(19) United States
(12) Patent Application Publication
(10) Pub. No.: US 2017/0015078 A1
(43) Pub. Date: Jan. 19, 2017

(54) Apparatus and Method for Pre-Folding Packaging Sleeves

(71) Applicant: SIG TECHNOLOGY AG, Neuhausen am Rheinfall (CH)

(72) Inventors: Bernd von Birgelen, Waldfeucht (DE); Markus Jenkel, Eschweiler (DE); Klaus Naber, Kempen (DE)

(73) Assignee: SIG Technolgy AG, Neuhausen am Rheinfall (CH)

(21) Appl. No.: 15/121,143

(22) PCT Filed: Jan. 29, 2015
(86) PCT No.: PCT/EP2015/051794

§ 371 Date: Aug. 24, 2016

(30) Foreign Application Priority Data
Feb. 24, 2014 (DE) 10 2014 102 333.1

(51) Int. Cl. B31B 3/26

(52) U.S. Cl. CPC B31B 3/26; B31B 2201/24; B31B 2201/26; B31B 2203/066

(57) ABSTRACT

Shown and described is an apparatus for the pre-folding of packaging sleeves including: at least one folding device with folding tools for pre-folding the bottom surfaces of a packaging sleeve and at least one folding device with folding tools for pre-folding the gable surfaces of a packaging sleeve. In order to achieve a precise and rapid pre-folding of the gable surfaces of a packaging sleeve on a compact system, it is proposed that all the folding devices are mounted movably in the vertical and in the horizontal direction. In addition, a method for the pre-folding of packaging sleeves is shown and described.

The invention relates to an apparatus for the pre-folding of packaging sleeves comprising: at least one folding device with folding tools for the pre-folding of the bottom surfaces of a packaging sleeve and at least one folding device with folding tools for the pre-folding of the gable surfaces of a packaging sleeve.

The invention additionally relates to a method for the pre-folding of packaging sleeves.

Packagings can be produced in the most diverse ways and from the most diverse materials. A widely used possible method for manufacturing consists in producing from a packaging material a blank usually having score lines, from which firstly a packaging sleeve and finally a packaging is formed by folding and further steps. This variant has inter alia the advantages that the blanks are very flat and therefore can be stacked in a space-saving manner. In this way, the blanks or packaging sleeves can be manufactured at a different location to that at which the folding and filling of the packaging sleeves takes place. Composite materials are frequently used as material, for example, a composite of several thin layers of paper, board, plastic or metal. Such packagings are in particular widely used in the food industry.

Before the packaging sleeves can be finally folded and closed, a so-called pre-folding frequently takes place. In this case, in order to reduce the folding forces required during the subsequent final folding, the individual layers of the composite materials are broken along the score lines provided which is why there is also talk of a “pre-breaking”. A pre-folding of the packaging sleeves additionally has further advantages. Firstly, the pre-folding—unlike the final folding—can take place before the sterilization and/or the filling of the packaging sleeves so that during the pre-folding folding tools which are inserted into the interior of the packaging sleeves can also be used. During the pre-folding it is therefore possible to make the folding tools act on the packaging sleeves on both sides, i.e. both from the inner side and also from the outer side. This is scarcely still possible after sterilization and/or the filling of the packaging sleeves for hygiene reasons. By using folding tools which act on both sides, the packaging sleeves can be pre-folded particularly precisely, in particular very precise folding edges can be produced. In addition, a specific folding direction can already be predefined by the pre-folding so that particularly simple tools can be used for the final folding. These simple tools can, for example, comprise fixed rails which fold down the pre-folded regions of the packaging sleeves which are guided past on rails.

Known from EP 0 112 605 A2, for example, is a system for folding and filling cartons with liquids such as milk or juice. In the system described the packaging sleeves are moved through pockets which are fastened to a revolving conveyor chain. The system also comprises stations for pre-folding (“pre-breaking”) the packaging sleeves. Firstly the upper regions of the packaging sleeves are pre-folded in a first station (“top closure pre-breaking turret 6”). Then the lower regions of the packaging sleeves are pre-folded in a second station (“bottom closure pre-breaker 8”).

The system described in EP 0 112 605 A2 has the disadvantage that two separate stations are required for the pre-folding of the packaging sleeves. This has the consequence that the system must have a particularly great extension in order to be able to accommodate both pre-folding stations. Another disadvantage is that different folding tools are used for the pre-folding of the upper regions of the packaging sleeves than are used for the pre-folding of the lower regions of the packaging sleeves. This is due inter alia to the fact that during the pre-folding of the upper regions the packaging sleeves move along a circular path, i.e. execute a rotational movement whereas during the pre-folding of the lower regions they move along a straight line, i.e. execute a translational movement. In many cases however the use of different folding tools also leads to qualitatively different folding results.

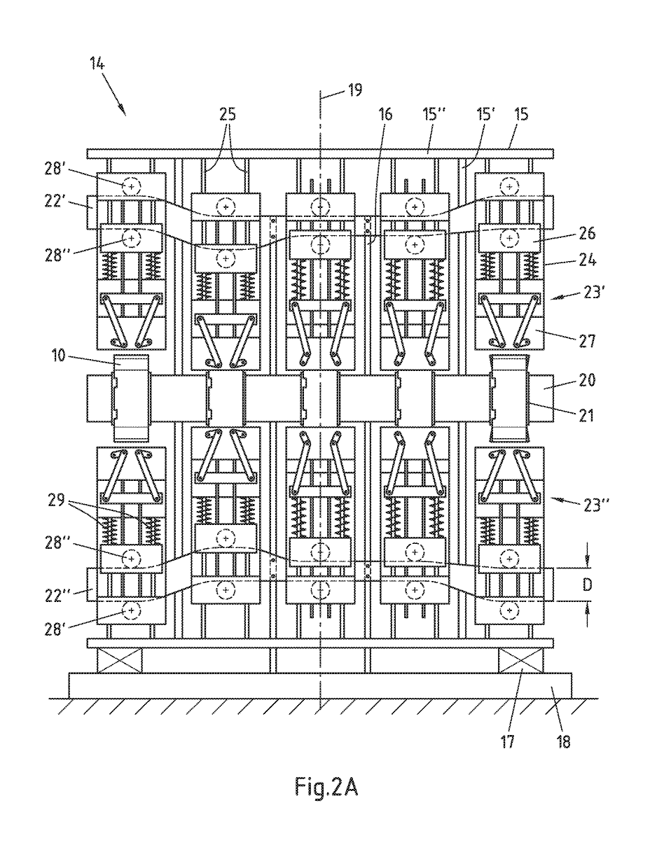

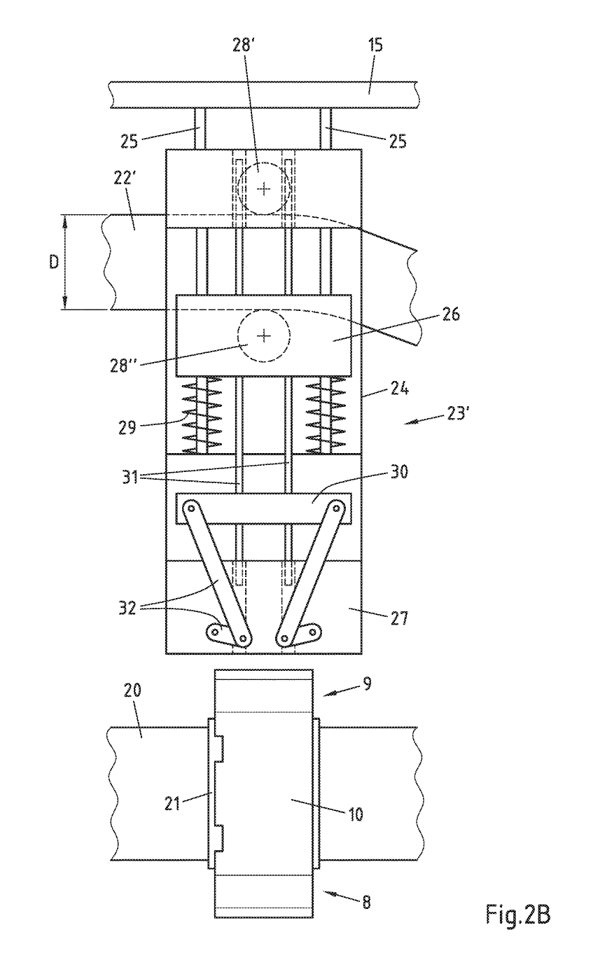

An alternative system is known from EP 0 615 909 A1. In this system the packaging sleeves are also transported by circulating conveyor belts on which carriers are fastened. The system described comprises two separate conveyor belts which are disposed in two planes located one above the other. The packaging sleeves must accordingly be transferred from the lower conveyor belt to the upper conveyor belt in the course of their processing. The transfer of the packaging sleeves takes place in a transfer section (“transfer portion 16”) in which six packaging sleeves are pushed with the aid of a transfer bridge (“transfer bridge 20”) located below the packaging sleeves from the carriers of the lower conveyor belt into the carriers of the upper conveyor belt. Initially in this case the packaging sleeves are only in contact with V-shaped lifting devices (“lifting devices 19”) on their lower side. Shortly before the end of the transfer the packaging sleeves also touch the pre-folding devices (“prefolding devices 41”) with their upper side. As a result of the V-shaped shape of the lifting devices and the pre-folding devices, the packaging sleeves are pressed inwards at the top and bottom on respectively two opposite sides so that a pre-folding of the packaging sleeves is accomplished (FIG. 2 of EP 0 615 909 A1).

The system disclosed in EP 0 615 909 A1 has the advantage compared with the previously described system that the folding tools which are used on the upper side of the packaging sleeves and the folding tools which are used on the lower side of the packaging sleeves are identically shaped so that the folding results are also of the same quality. An appreciable disadvantage however is that during the transfer of the packaging sleeves from the lower conveyor belt to the upper conveyor belt, both the lower conveyor belt and the upper conveyor belt must be stopped. This is because, inter alia, both the lower lifting devices and also the upper pre-folding devices can only be moved in the vertical direction. Thus, the pre-folding can only take place when the conveyor belts are at a stillstand. This has the consequence that the entire system must be stopped during the pre-folding with the result that the performance of this system is reduced appreciably. In particular, no continuous operation can take place in the system shown in EP 0 615 909 A1; instead an intermettend operation must take place. Along with the lower capacity, this has the result that both the system itself and the contents to be filled are very severely loaded as a result of the frequently repeated braking and acceleration processes of the conveyor belts. In the case of the system this can result in increased wear, in the case of the contents to be filled, there is a risk of foam formation, escaping splashes or even slopping over of the contents.

Against this background, it is the object of the invention to configure and further develop the device mentioned initially and described previously in detail as well as the method mentioned initially and described previously in detail in such a manner that a precise and rapid pre-folding of both sides of the packaging sleeves can take place on a compact system.

This object is achieved in a device according to the preamble of patent claim 1 in that all the folding devices are mounted movably in the vertical and in the horizontal direction.

The apparatus according to the invention is initially characterized by one or more folding devices with folding tools for pre-folding the lower surfaces, i.e. the bottom surfaces of a packaging sleeve. In addition, the apparatus according to the invention comprises one or more folding devices with folding tools for pre-folding the upper surfaces, i.e. the gable surfaces of a packaging sleeve. Accordingly, this comprises a device which can pre-fold both the bottom surfaces and the gable surfaces of a packaging sleeve.

According to the invention, the folding devices are mounted movably in the vertical and in the horizontal direction. The packaging sleeves are preferably aligned upright, i.e. in the vertical direction since they can be particularly easily filled in this position. Preferably the upper folding devices are located above the packaging sleeves and the lower folding devices are located below the packaging sleeves.

As a result of the vertical mobility of the folding devices, it is achieved that the upper folding device can be moved in the direction of the gable surfaces of the packaging sleeve and moved away again from the gable surfaces. Correspondingly the lower folding device can be moved in the direction of the bottom surfaces of the packaging sleeve and moved away again from the bottom surfaces. The vertical mobility of the folding devices therefore has the advantage that the packaging sleeves themselves need not be moved in the vertical direction during the pre-folding. This facilitates the guidance and transport of the packaging sleeves.

As a result of the horizontal mobility of the folding devices, it is achieved that the folding devices can follow the movement of the packaging sleeves. The horizontal movement can be a straight movement or a curved, in particular circular movement if the straight line or the curve lies in a horizontal plane. This enables the folding devices to follow the transport path of the packaging sleeves. The advantage of this mobility lies in that the packaging sleeves need not be stopped during the pre-folding but can be moved further—for example, by a conveyor belt. In other words the horizontal mobility of the folding devices enables a continuous, interruption-free movement of the packaging sleeves during the pre-folding.

One embodiment of the invention is characterized by a rotary frame which is mounted rotatably about an axis of rotation running centrally through the device. The rotary frame is preferably circular so that the components disposed on the rotary frame, for example, the folding devices are arranged circularly. Such a device is also designated as “rotary machine” and is particularly compact. Another advantage is that a device configured as a rotary machine can be embraced particularly efficiently by a conveyor belt carrying the packaging sleeves and in this way can drive the conveyor belt or can be driven by the conveyor belt. The rotating mounting of the rotary frame can be achieved by a rotary connection, for example, by a roller bearing which is disposed between the rotary frame and a stationary foot.

According to a further embodiment of the invention, it is provided that the rotary frame comprises vertically running rods on which the folding devices are mounted movably, in particular movably in the vertical direction. Preferably each folding device is mounted on two rods so that the folding devices can be guided in a torsion-proof manner. In order to ensure a precise but smooth-running guidance, the folding devices should have two feed-throughs per rod in their frame, the diameter of which is slightly larger than the diameter of the rods.

Another embodiment of the invention is characterized by a stationary fixed frame which is disposed inside the rotary frame. In contrast to the previously described rotary frame, the fixed frame cannot execute any rotation; it is instead stationary. The fixed frame is used for fastening those parts of the device which are not intended to rotate jointly with the rotary frame. For example, an electric motor for driving the rotary frame can be mounted on the fixed frame.

In a further embodiment of the invention, it is proposed to provide a lower control rail which is fastened to the fixed frame and along which the at least one folding device for pre-folding the bottom surfaces of the packaging sleeves is movably guided, in particular by rollers. Alternatively or additionally, it is proposed to provide an upper control rail which is fastened to the fixed frame and along which the at least one folding device for pre-folding the gable surfaces of the packaging sleeves is movably guided, in particular by rollers. Since the control rails are fastened to the fixed frame, they are stationary. In contrast to the folding devices, they are therefore movable neither in the vertical nor in the horizontal directions during the production operation of the device. This enables the control rails to be used for controlling the position of the folding devices. Since the folding devices are guided along the control rails, for example by rollers, a variation in the position of the control rails also leads to a variation in the position of the folding devices. In particular, the position of the folding devices in the vertical direction can be influenced or adjusted by the vertical position of the control rails. This principle is comparable to the guidance of rail vehicles by the course of the rails and has the advantage that the position of the folding devices can be varied purely mechanically and therefore extremely reliably.

In this embodiment of the invention, it is advantageous if the distance which the lower control rail and the upper control rail have from one another is adjustable. In this way, it is possible to produce or process packagings having different filling volumes on one and the same device. The packagings can, for example, having the same packaging cross-section and differ only in their packaging height for receiving different volumes. Here it is of particular advantage if the distance between the two control rails is adjustable in predefined steps, where the steps correspond to different folded boxes or packaging shapes. For example, a device for fixing the distance between the lower and the upper control rail can provide two to six positions or steps. In order to ensure a particularly stable stopping of the control rails which are again stationary in the production process, it is particularly practical if the device for fixing the distance between the upper and the lower control rail has stops in which locking device on the control rail side can engage. The appurtenance of stop and locking device between control rail and device for fixing the distance between the upper and the low control rail can be exchangeable.

Although it is feasible in view of the adjustability of the control rails that both the upper and the lower control rail are configured to be adjustable, it is more economical if the distance adjustment required for the volume adjustment can be achieved by the adjustment of only one control rail. A particularly uncomplicated adjustment to the peripheral devices surrounding the apparatus is obtained if only the lower control rail is configured to be adjustable in the vertical direction.

With a view to the control rails, it is further proposed that the lower control rail and/or the upper control rail have a thickness which varies along their length. As a result of a varying thickness of the control rails, further functions of the folding devices, for example, the triggering of the folding process, can be controlled or activated. For this purpose the folding devices can be guided along the control rails in such a manner that a variation in the thickness of the control rail results in a movement of a component of the folding device, for example, the folding tools. It can be provided in this respect that the folding device is guided by means of two rollers along the control rail, where the rollers roll on opposite surfaces of the control rail. In this way a variation in the thickness of the control rail results in a variation in the distance between the two rollers. Since one of the two rollers is mounted movably or displaceably, this variation in distance can be used in the manner described, for example, for activating the folding tools. The folding tools can therefore be controlled purely mechanically and therefore extremely reliably by control rails having varying thickness.

A further embodiment of the invention provides that the folding devices comprise a rigid frame and a carriage which is mounted movably relative to the frame. The relative movement between the frame and the carriage can be used for guidance of the folding device along the control rail. For example, a first roller can be provided in the frame and a second roller can be provided on the movable carriage. The control rail can then—for example, by a spring force—be clamped between the “frame roller” and the “carriage roller” so that the two rollers roll reliably on the control rail as a result of the pressing force. The mobility of the carriage facilitates the placement of the rollers on the control rail. In addition, the change in the position of the carriage, which is caused for example, by a thickness variation of the control rail, can be specifically used for controlling further components such as the folding tools.

To this end, it is proposed in a further embodiment of the invention that the movable carriage is connected mechanically to the folding tools. As a result of a direct mechanical connection, the movement of the carriage can be transferred directly to the folding tools in order to initiate or stop the folding process. This allows a particularly simple and robust construction.

Alternatively or additionally to this, a further embodiment of the invention provides that the movable carriage is connected mechanically to a control carriage by at least one guide rail. For this embodiment it is further proposed that the control carriage is connected mechanically to the folding tools by at least one coupling rod. In this variant the movable carriage is therefore connected to the folding tools not (only) directly but (also) indirectly via a control carriage and at least one coupling rod. As a result of this constructive solution, the movement of the carriage can be transferred to the folding tools in a particularly variable manner. For example, a translational movement of the carriage can be converted into a rotational movement by means of a plurality of coupling rods connected to one another in an articulated manner. This allows the simultaneous triggering of folding tools which execute a translational movement (triggering via the movable carriage or the control carriage) and of folding tools which execute a rotational or pivoting movement (triggering via the coupling rods).

According to a further teaching of the invention, it is proposed that the apparatus comprises at least six folding devices for pre-folding the bottom surfaces of the packaging sleeves and at least six folding devices for pre-folding the gable surfaces of the packaging sleeves. As a result of the high number of folding devices, a plurality of packaging sleeves can be pre-folded at the same time. In particular, the pre-folding of a second and further packaging sleeve can be commenced before the pre-folding of the first packaging sleeve is ended. A plurality of packaging sleeves are therefore pre-folded at the same time, where the individual packaging sleeves are located in different folding states. Preferably the apparatus has twelve folding devices for pre-folding the bottom surfaces of the packaging sleeves and twelve folding devices for pre-folding the gable surfaces of the packaging sleeves.

According to a further embodiment of the invention, it is proposed that each folding device comprises a plurality of movably mounted folding tools. This enables the pre-folding to be carried out particularly precisely and from several sides at the same time. The movably mounted folding tools can comprise, for example, two oppositely disposed surface folders and two oppositely disposed ear folders. In addition, a centrally disposed counterholder can be provided which is inserted into the packaging sleeve. Preferably the surface folder and the ear folder are mounted pivotably whilst for the counterholder a displaceability in the vertical direction is sufficient.

Finally, according to a further embodiment of the invention, means are provided for positive connection to a conveyor belt with cells fastened thereon. This can, for example, comprise a toothed structure which is disposed on the apparatus, in particular on the rotary frame of the apparatus. A positive connection provides a slippage-free transmission of the drive power and therefore has the advantage that the movements of the conveyor belt and of the folding tools take place synchronously. This enables a very precise alignment of the folding tools relative to the packaging sleeves. A further advantage of a positive connection lies in its releasability. This enables the conveyor belt to wrap around the apparatus only partially and after the pre-folding, this can be released from the apparatus again in order to transport the packaging sleeves to further stations of a filling plant.

The object described initially is also solved by a method according to patent claim 16. This method comprises the following steps: a) aligning a packaging sleeve, b) pre-folding the gable surfaces of this packaging sleeve and c) pre-folding the bottom surfaces of this packaging sleeve, wherein steps b) and c) overlap temporally. A temporal overlap is understood such that the first step is not completed before the second step has begun. Steps b) and c) therefore need not take place synchronously; a temporal overlap is sufficient.

The method is characterized according to the invention in that the packaging sleeve is moved in the horizontal direction. The packaging sleeve should be moved in the horizontal direction in particular in steps b) and c). A movement in the horizontal direction does not preclude the packaging sleeve from also moving in the vertical direction; it is sufficient that the direction of movement of the packaging sleeve includes a horizontal component. Preferably however the packaging sleeve moves exclusively in the horizontal direction. As has already been explained previously, the horizontal movement can be a straight movement or a curved, in particular circular, movement if the straight line or the curve lies in a horizontal plane.

Carrying out the pre-folding during a horizontal movement of the packaging sleeve has the advantage of a particularly high performance of the system. The high performance is due to the fact that the packaging sleeves need not be stopped during the pre-folding but can be moved further in the horizontal direction—for example, by a conveyor belt. In other words, the horizontal movement of the packaging sleeves during the pre-folding enables a continuous interruption-free operation of the system.

A further development of the invention provides that the packaging sleeve is moved at constant speed. The packaging sleeve should be moved at constant speed in particular in steps b) and c). Alternatively it can be provided that the speed of the packaging sleeve is varied, where however the speed is always greater than zero. For example, a cyclic variation of the speed, in particular a fluctuation about a mean can be provided. The packaging sleeves should not be stopped at any time in any case as would be the case with an intermittent operation. A cyclic variation of the speed of the packaging sleeves enables an optimization of certain process steps, for example, the insertion of the packaging sleeves into the cells. However a constant speed of the packaging sleeves is preferred. During a movement along a circular path merely the magnitude of the speed of the packaging sleeves can be constant [or the angular speed is constant], during a movement along a straight line on the other hand, both the magnitude and also the direction of the speed of the packaging sleeves can be constant.

According to a further teaching of the invention, it is proposed that the packaging sleeve is moved along a circular path. The packaging sleeve should be moved along a circular path in particular in steps b) and c). Since the pre-folding takes place along a circular path the device for pre-folding can be particularly compact and in particular configured as “rotary machine”. In addition, as a result of the guidance of the packaging sleeves along a circular path, a reversal of the transport path can be achieved so that the further stations of a complete system can also be arranged particularly compactly.

In a further embodiment of the invention, it is provided that the packaging sleeve is moved by a conveyor belt with holders or cells fastened thereon. The packaging sleeves can be moved rapidly and reliably by a conveyor belt. The conveyor belt is preferably designed to be closed, i.e. “endless”. As a result of its flexibility, a conveyor belt has the advantage that it can be guided around two—or more—rotary machines.

In this way, the conveyor belt runs partially curved (in the region of the rotary machine) and partially straight (in the regions between the rotary machines). This enables a particularly variable and compact arrangement of the individual stations of a filling plant. The conveyor belt can be connected non-positively, i.e. by frication or positively, for example, by teeth to the rotary machines and in this way transfer drive forces. The cells can be configured to be rigid and have at least one spring element for clamping the packaging sleeves in the cells.

According to a further embodiment of the invention, in steps b) and c) a counterholder is inserted into the packaging sleeve. Preferably the counterholder is inserted into the interior of the packaging sleeve by a vertical movement. Since a tool is inserted into the packaging sleeve, a particularly precise pre-folding is possible. In particular, the tool inserted into the packaging sleeve can serves as a counterbearing for other tools which pre-fold the packaging sleeve from the outer side.

A further embodiment of the invention provides that in steps b) and c) two oppositely arranged surface holders are pivoted in the direction of the packaging sleeve. The bottom surfaces and/or gable surfaces of the packaging sleeve can be folded inwards particularly accurately by the rotatably or pivotably mounted surface folder. In particular as a result of the pivoting movement it is possible to place the surface folders flat on the surfaces of the packaging sleeve to be folded down and maintain this flat contact during the entire folding process. In contrast to a point contact, this has the advantage of a particular gentle pre-folding whereby wrinkles and bulges as well as damage to the decoration in the packaging sleeve can be avoided.

According to a further teaching of the invention it is proposed that in steps b) and c) two oppositely arranged ear folders are pivoted away from the packaging sleeve. As a result of the rotatably or pivotably mounted ear folders, the ear folders can follow the outwardly directed movement of the bottom surfaces and/or the gable surfaces of the packaging sleeve in this region. Through the pivoting movement of the ear folders, the bottom surfaces and/or the gable surfaces of the packaging sleeve can thus be supported from below in the region of the protruding ears whereas the surface folders press the material of the packaging sleeve in this region in the direction of the centre of the packaging sleeve. The ear folders can have a triangular region whereby the ear folders can support one of the triangular surfaces of the packaging sleeve flat from below. In contrast to a point contact, this has the advantage of a particular gentle pre-folding whereby wrinkles and bulges in the packaging sleeve can be avoided.

Preferably the surface folders are arranged displaceably and to this end mounted in a guide where the guide is configured in such a manner that it allows a displaceability of the surface folders in the horizontal direction or in a direction inclined at an angle to the horizontal direction. This angle preferably lies in a range between 3° and 18°. Furthermore, in connection with the design of the surface folders it is preferable if these have contact surfaces which are provided for contact with the subsequent gable or bottom surfaces of the packaging to be produced. The contact surfaces are preferably aligned at an angle to a vertical plane and in particular configured such that they form a funnel which is open towards the top or towards the bottom and towards the packaging sleeve with the contact surface of a surface folder which is located opposite thereto and which becomes effective in a working process jointly on respectively the same packaging sleeve. A preferred funnel angle in this case lies between 5° and 50° depending on the packaging shape.

In other cases, it can be preferable if the surface folders are pivotably mounted and arranged in pairs in such a manner that they can be pivoted towards one another from a rest position into a working position in which they come into contact with the packaging sleeve to be processed or the packaging to be produced.

Regardless of whether the surface folders are arranged displaceably or pivotably, they can also be used for pre-folding the subsequent packaging ears. In this way, the movement expenditure related to the entire folding device is reduced. Nevertheless however, in order to achieve particularly good results the provision of at least one separate ear folder is proposed. The ear folders which are likewise preferably arranged in pairs and opposite one another are expediently pivotably mounted.

In a particularly preferred manner it can additionally be provided that the ear folder is designed and configured in such a manner that an active folding back of the ears formed by the pre-folding takes place during a working cycle. In this case it is preferable that the back-folding does not again raise the entire folding path of the pre-folding but only a relatively small portion thereof, for example less than 20%. This is usually sufficient to free the packaging regions after the stress state adopted as a result of the pre-folding initiated “breakup” of the score lines and move over the dead point. If the ears are pre-folded, the subsequent gable surfaces connected to them project into the movement space of the centrally arranged counterholders and thus ensure—if there is no active back-folding—an increased withdrawal resistance of the counterholders when these are moved out from the space enclosed by the pre-folded packaging sleeve. In this case, the risk of an undesired change in position of the packaging sleeve with respect to the cell carrying it is also necessarily increased. Damage to the innermost barrier layer of the packaging sleeve—and therefore to the subsequent packaging—can also occur in this case, with the result that the protective properties of the packaging would be reduced.

According to a further embodiment of the invention, step b) begins earlier than step c). Alternatively it can be provided that step c) begins earlier than step b). Since the pre-folding of the gable surfaces and the bottom surfaces does not begin at the same time but offset in time, the packaging sleeves can be particularly well aligned. The alignment of the packaging sleeves can, for example, be taken over by the folding tools which are first used. If the pre-folding of the gable surfaces is commenced, for example, the upper folding tools can align the packaging sleeve by pushing this downwards a little way before the pre-folding of the gable surfaces begins. This type of alignment functions as a result of the fact that the pre-folding of the gable surfaces and the bottom surfaces does not begin at the same time but offset in time.

In a further embodiment of the invention it is proposed that step c) is ended earlier than step b). Alternatively it can be provided that step b) is ended earlier than step c). The crucial factor is that the pre-folding is the last to end on that side on which it was first begun. If therefore the pre-folding of the gable surfaces has begun before the pre-folding of the bottom surfaces, the pre-folding of the bottom surfaces should be ended before the pre-folding of the gable surfaces. This procedure facilitates the precise alignment of the packaging sleeve since it is ensured that for example the upper folding tools are continuously in contact with the packaging sleeve whereas for example the lower folding tools are only activated later and deactivated again earlier. This makes it possible to carry out the alignment and guidance of the packaging sleeves on one side—i.e. for example only by the upper folding tools.

Alternatively to this, according to a further embodiment of the invention it is finally provided that step b) and step c) take place completely synchronously. This means that the pre-folding of the gable surfaces and the bottom surfaces begins at the same time and ends at the same time. This certainly makes the alignment of the packaging sleeves difficult but has the advantage that very many identical parts can be used in the apparatus since the upper half of the apparatus operates almost “as a mirror image” of the lower half of the apparatus. A further advantage lies in that the size of the apparatus can be adapted to the duration of the pre-folding since the pre-folding of both sides of the packaging sleeve starts at the same time and therefore is also ended at the same time. The total duration of the pre-folding therefore corresponds to the duration of the pre-folding of the gable surfaces or the bottom surfaces.

The invention is explained in detail hereinafter with reference to drawings showing merely one exemplary embodiment. In the figures:

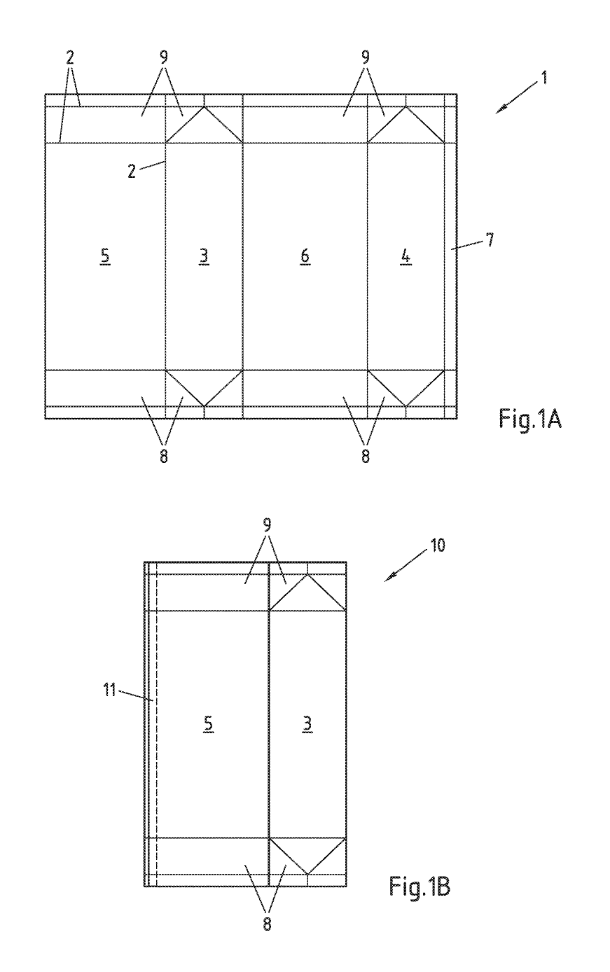

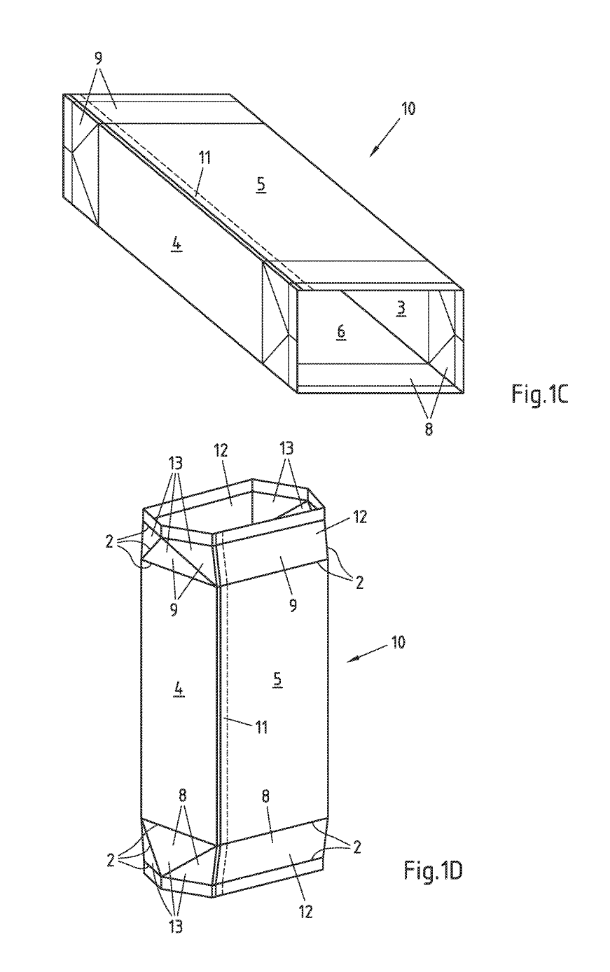

FIG. 1A shows a blank for folding a packaging sleeve known from the prior art,

FIG. 1B shows a packaging sleeve known from the prior art which is formed from the blank shown in FIG. 1A, in the flat-folded state,

FIG. 1C shows the packaging sleeve from FIG. 1B in the unfolded state,

FIG. 1D shows the packaging sleeve from FIG. 1C with pre-folded bottom and gable surfaces,

FIG. 2A shows an apparatus according to the invention for pre-folding packaging sleeves in a front view,

FIG. 2B shows an enlarged view of a folding device from FIG. 2A,

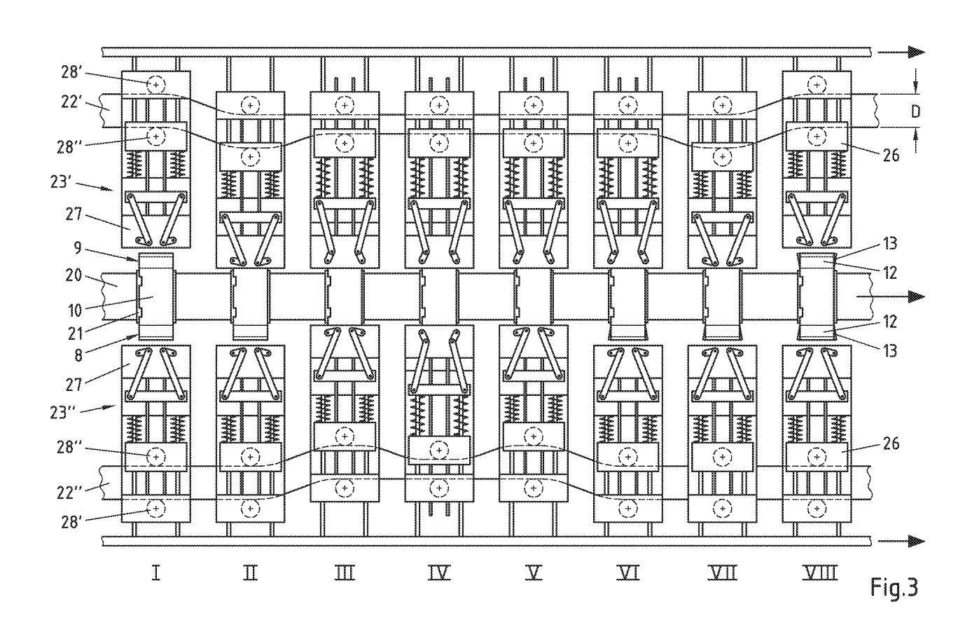

FIG. 3 shows a schematic view of the process steps in the pre-folding of packaging sleeves,

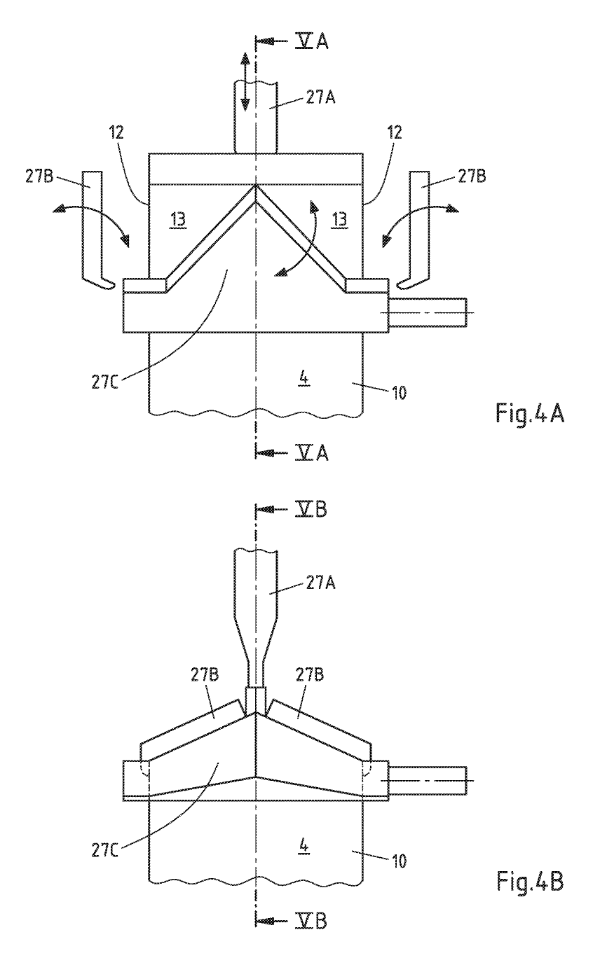

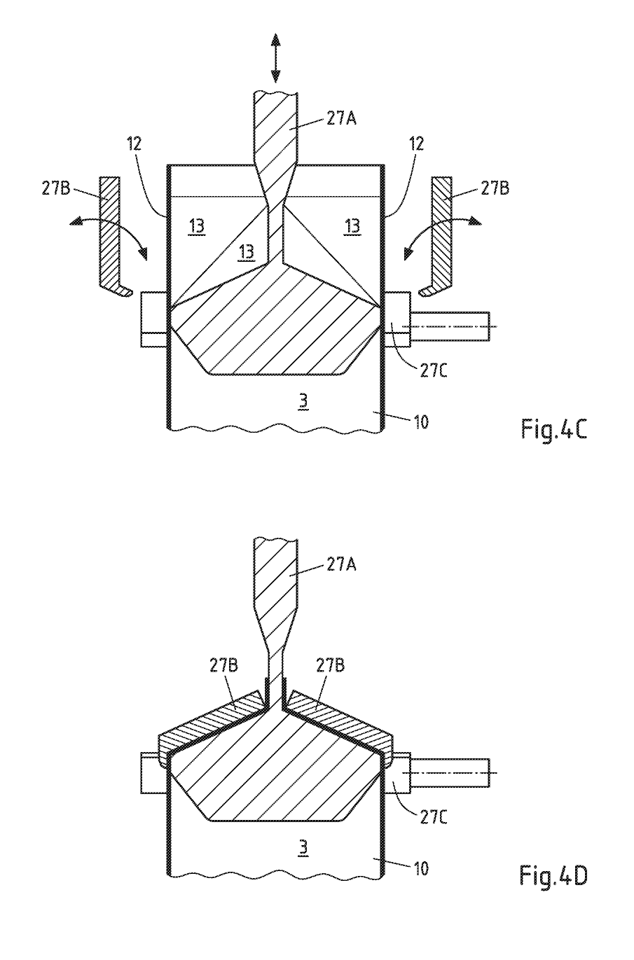

FIG. 4A shows the folding tools of an apparatus according to the invention in the open position in a side view,

FIG. 4B shows the folding tools of an apparatus according to the invention in the closed position in a side view,

FIG. 4C shows the folding tools in the position from FIG. 4A in cross-section,

FIG. 4D shows the folding tools in the position from FIG. 4B in cross-section,

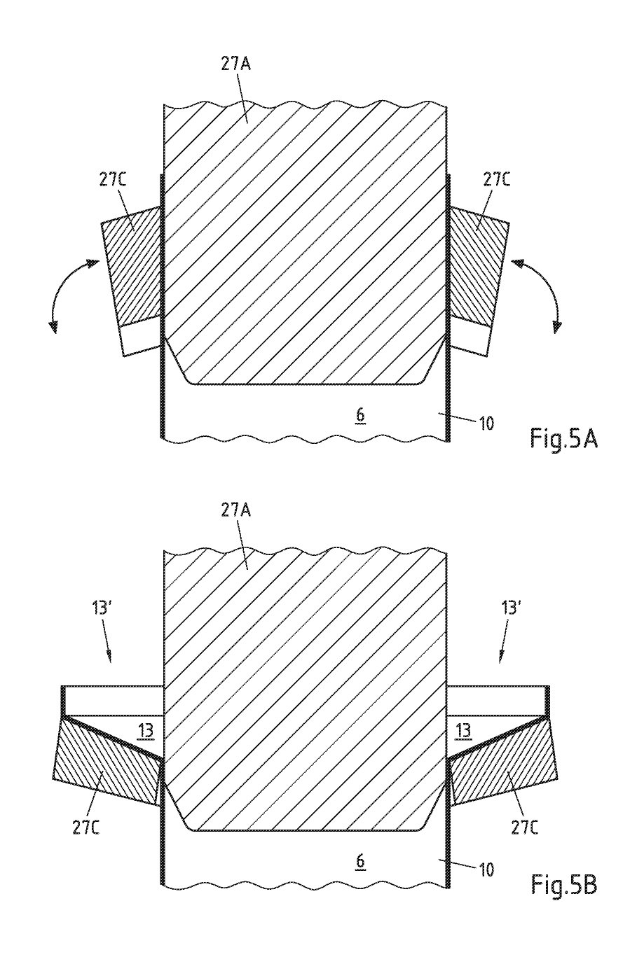

FIG. 5A shows the folding tools of an apparatus according to the invention in the open position in the cross-section along the line VA-VA from FIG. 4A,

FIG. 5B shows the folding tools of an apparatus according to the invention in the closed position in the cross-section along the line VB-VB from FIG. 4B, and

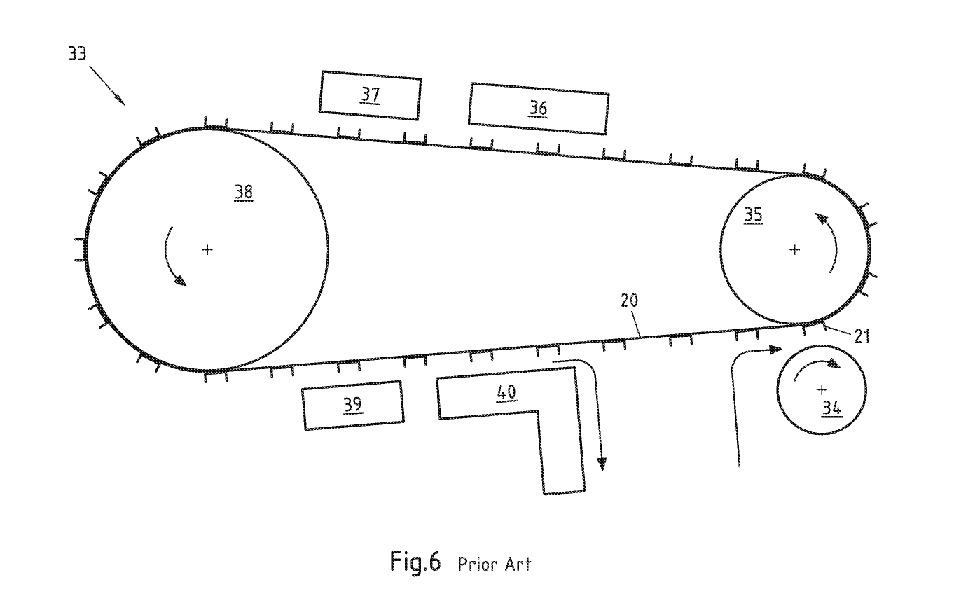

FIG. 6 shows a system known from the prior art for filling packages with foodstuffs.

FIG. 1A shows a blank 1 known from the prior art from which a packaging sleeve can be formed. The blank 1 can comprise a plurality of layers of different materials, for example, paper, board, plastic or metal, in particular aluminium. The blank 1 has a plurality of fold lines 2 which should facilitate the folding the blank 1 and divides the blank 1 into a plurality of surfaces. The blank 1 can be divided into a first side surface 3, a second side surface 4, a front surface 5, a rear surface 6, a sealing surface 7, bottom surfaces 8 and gable surfaces 9. A packaging sleeve can be formed from the blank 1 by folding the blank 1 in such a manner that the sealing surface 7 can be joined, in particular welded to the front surface 5.

FIG. 1B shows a packaging sleeve 10 known from the prior art in the flat folded state. The regions of the packaging sleeve already described in connection with FIG. 1A are provided with corresponding reference numbers in FIG. 1B. The packaging sleeve 10 is formed from the blank 1 shown in FIG. 1A. For this purpose, the blank 1 was folded in such a manner that the sealing surface 7 and the front surface 5 are arranged in an overlapping manner so that the two surfaces can be welded flat to one another. As a result, a longitudinal seam 11 is formed. FIG. 1B shows the packaging sleeve 10 in a flat folded-together state. In this state one side surface 4 (concealed in FIG. 1B) lies under the front surface 5 whilst the other side surface 3 lies on the rear surface 6 (concealed in FIG. 1B). In the flat folded-together state a plurality of packaging sleeves 10 can be stacked in a particularly space-saving manner. Thus, the packaging sleeves 10 are frequently stacked at the place of manufacture and are transported in stacks to the filling location. Only there are the packaging sleeves unstacked and unfolded in order to be able to be filled with contexts, for example, with foodstuffs.

FIG. 1C shows the packaging sleeve 10 from FIG. 1B in the unfolded state. Here also the regions of the packaging sleeve 10 already described in connection with FIG. 1A or FIG. 1B are provided with corresponding reference numbers. The unfolded state is understood as a configuration in which an angle of about 90° is formed between the two respectively adjacent surfaces 3, 4, 5, 6, so that the packaging sleeve 10—depending on the shape of these surfaces—has a square or rectangular cross-section. Accordingly the opposite side surfaces 3, 4 are arranged parallel to one another. The same applies for the front surface 5 and the rear surface 6.

FIG. 1D shows the packaging sleeve 10 from FIG. 1C in the pre-folded state, i.e. in a state in which the fold lines 2 have been pre-folded both in the region of the bottom surfaces 8 and in the region of the gable surfaces 9. These regions of the bottom surfaces 8 and the gable surfaces 9 which adjoin the front surface 5 and the rear surface 6 are also designated as rectangular surfaces 12. The rectangular surfaces 12 are folded inwards during the pre-folding and subsequently form the bottom or the gable of the packaging. Those regions of the bottom surfaces 8 and the gable surfaces 9 which adjoin the side surfaces 3, 4 are on the other hand designated as triangular surfaces 13. The triangular surfaces 13 are folded outwards during the pre-folding and form projecting regions of excess material which are also designated as “ears” 13′ and in a subsequent manufacturing step are placed on the packaging—possibly by gluing processes.

FIG. 2A shows an apparatus 14 according to the invention for the pre-folding of packaging sleeves 10 in a front view. The apparatus 14 shown in FIG. 2A comprises a rotary machine. The apparatus 14 comprises a rotary frame 15 which comprises a plurality of vertically running supporting elements 15′ and a plurality of horizontally running supporting elements 15″. The apparatus 14 additionally has a fixed frame 16 which is disposed inside the rotary frame 15. The rotary frame 15 is rotatably connected to a base 18 by a bearing 17 which preferably comprises an axial roller bearing. The rotary frame 15 can therefore rotate about an axis of rotation 19 which runs in the vertical direction centrally through the apparatus 14. The fixed frame 16 on the other hand is connected directly to the base 18 and therefore cannot rotate. The apparatus 14 accordingly comprises a rotatable part and a non-rotatable part.

The apparatus 14 has a conveyor belt 20 wrapped around it—in each case in its region shown in FIG. 2A—approximately at half height, to which a plurality of cells 21 are fastened. The cells 21 are used to receive packaging sleeves 10 which, for example, can be clamped in the cells 21. The conveyor belt 20 does not wrap around the apparatus 14 completely but only in a partial region which, for example, can be between 160° and 180°. In the remaining region, i.e. in the region of the “rear side” of the apparatus 14 not shown in FIG. 2A, the conveyor belt 20 is detached from the apparatus 14 and leads to other apparatuses which can be part of a filling system for foodstuffs.

The rotation of the rotary frame 15 can be achieved in various ways. One variant can provide that the rotary frame 15 has its own drive, for example, an electric motor. This drive can rotate the rotary frame 15 and at the same time drive the conveyor belt 20.

An alternative variant can provide that the rotary frame 15 does not have its own drive but is co-rotated with the conveyor belt 20. In this case, the conveyor belt 20 must naturally be driven by a drive outside the apparatus 14. In order to be able to transfer the drive forces between the rotary frame 15 and the conveyor belt 20, preferably a positive connection is formed between both parts. To this end the inner side of the conveyor belt 20 can, for example, have teeth which—as in the case of a toothed belt—engage in correspondingly shaped teeth which are provided on the rotary frame 15. By means of a positive connection, a synchronous movement of rotary frame 15 and conveyor belt 20 can be achieved.

The apparatus 14 shown in FIG. 2A additionally has two control rails 22 of which the upper control rails 22′ is disposed above the conveyor belt 20 and of which the lower control rail 22″ is disposed underneath the conveyor belt 20. The control rails 22 are fastened to the stationary fixed frame 16 and therefore do not co-rotate during a rotation of the rotary frame 15. Nevertheless it can be provided that the distance between the upper control rail 22′ and the lower control rail 22″ is adjustable in order to be able to manufacture or process packagings having different filling volumes. To this end the upper control rails 22′ and/or the lower control rail 22″ can, for example, be designed to be displaceable in the vertical direction. Preferably the distance between the two control rails 22 can be adjusted in predefined stages, where the stages correspond to different packaging formats. The vertical adjustability of the control rails 22 can, for example, be achieved by a stop and a locking device (not shown in FIG. 2A). Both control rails 22 carry a plurality of folding devices 23 which in turn can be divided into upper folding devices 23′ and lower folding devices 23″. The folding devices 23 have a rigid frame 24 which is displaceably mounted on rods 25 which for their part are firmly connected to the rotary frame 15. In this way the folding devices 23 can be displaced upwards and downwards in the vertical direction, i.e. parallel to the axis of rotation 19. Respectively one movable carriage 26 which is displaceably mounted is provided inside the rigid frame 24 of the folding devices 23. The carriage 26 can therefore be moved upwards and downwards relative to the frame 24 of the folding device 23. Each folding device 23 additionally has folding tools 27 for pre-folding the packaging sleeves 10.

The mounting and guidance of the folding devices 23 by the control rails 22 is accomplished in the apparatus 14 shown in FIG. 2A via rotatably mounted rollers 28. Each folding device 23 comprises a frame roller 28′ connected to the frame 24 and a carriage roller 28″ connected to the movable carriage 26. Each folding device 23 additionally has at least one spring 29 which for example comprises a spiral spring made of steel. Preferably the number of springs 29 per folding device 23 corresponds to the number of rods 25 so that the springs 29 run around the rods 25 and can be centred by these. The springs 29 are disposed in such a manner between the frame 24 and the moveable carriage 26 that they produce a compressive force which presses the carriage roller 28″ permanently in the direction of the frame roller 28′. As a result of this compressive force produced by the springs 29, the control rail 22 is clamped between the two rollers 28. During a rotation of the rotary frame 15, the rollers 28 of the folding devices 23 rotating together with the rotary frame 15 therefore roll on the surface of the stationary control rails 22. This has the consequence that the distance between the frame roller 28′ and the carriage roller 28″—and therefore also the distance between the frame 24 and the movable carriage 26—depends on the thickness D of the control rail 22. In regions in which the control rail 22 is thin or narrow, the carriage roller 28″ and therefore also the movable carriage 26 are pressed very tightly onto the frame roller 28′ by the springs 29. In regions in which the control rail 22 is thick or wide, the springs 29 are on the other hand compressed again so that the carriage roller 28″ and therefore also the movable carriage 26 are again moved away from the frame roller 28′.

In order to ensure a safe, controlled stopping of the rotary frame 15 of the apparatus 14 even with broken springs 29, spacers—not shown in FIG. 2A—can be provided on the movable carriages 26 of the upper and lower folding devices 23′, 23″. The spacers ensure that the movable carriages 26—and therefore also the carriage rollers 28″—only move insignificantly further away from the frame rollers 28′ than would be the case with functioning springs 29 in the maximum deflection of the movable carriages 26. In this way it is achieved that even with broken springs 29, the control rails 22′, 22″ can still provide a—certainly only very loose—guidance for the two rollers 28′, 28″. Preferably the spacers are configured to be adjustable.

In the apparatus 14 shown in FIG. 2A the movable carriages 26 are connected mechanically to the folding tools 27. This enables the folding tools 27 to be actuated by a movement of the carriages 26. The precise type of connection will be discussed in more detail in connection with FIG. 2B. For example, the folding tools 27 can be activated when the distance between the carriage rollers 28″ and the frame rollers 28′ is reduced and deactivated when the distance between the carriage rollers 28″ and the frame rollers 28′ is increased again. As a result of this arrangement, the control rails 22 can influence and control the folding devices 23 in multiple ways: as a result of a variation in the position of the control rails 22 the positions of the folding devices 23 can be varied; in particular, the folding devices 23 can be displaced in the vertical direction. As a result of a variation in the thickness D of the control rails 22 on the other hand, the positions of the movable carriages 26 relative to the frames 24 of the folding devices 23 can be varied whereby the folding tools 27 can be influenced.

FIG. 2B shows an enlarged view of a folding device 23 from FIG. 2A. The regions of the folding device 23 already described in connection with FIG. 2A are provided with corresponding reference numbers in FIG. 2B. The folding device 23 shown in FIG. 2B comprises an upper folding device 23′; for the lower folding devices 23″ however the same applies accordingly. As has already been described in connection with FIG. 2A, a variation in the thickness D of the control rail 22 results in a displacement of the movable carriage 26 in the vertical direction. As a result of a movement of the carriage 26, the folding tools 27 are activated or deactivated. For this purpose there is a mechanical connection between the carriage 26 and the folding tools 27.

In the folding device 23′ shown in FIG. 2B and in this respect preferred, the mechanical connection between the movable carriage 26 and the folding tools 27 is implemented as follows: the carriage 26 transfers its vertical movement to a control carriage 30. The control carriage 30 is connected by means of two guide rails 31 to the movable carriage 26 in such a manner that the distance between the movable carriage 26 and the control carriage 30 is always constant. In other words, the carriage 26 and the control carriage 30 move relative to the frame 24 of the folding device 23′ but not relative to one another. The synchronous movement of carriage 26 and control carriage 30 can, for example, be achieved by both the carriage 26 and also the control carriage 30 being firmly connected to the guide rails 31 whilst the guide rails 31 are movably guided in the frame 24 of the folding device 23′ and therefore can be displaced relative to the folding device 23′. The control carriage 30 is mechanically connected to the folding tools 27. This can be accomplished, for example, by coupling rods 32 mounted in an articulated manner.

In FIG. 2B the folding tools 27 are only shown schematically by a rectangular block. Preferably a folding device 23 according to the invention comprises five folding tools 27. Two of these folding tools 27 can be arranged opposite to one another, pivotably mounted and be used for the pre-folding of the rectangular surfaces 12 of the packaging sleeves 10. Two further ones of these folding tools 27 are also be arranged opposite one another, be pivotably mounted and be used for pre-folding the triangular surfaces 13 of the packaging sleeves 10. During a vertical movement of the carriage 26 these four folding tools 27 are pivoted by the coupling rods 32 or comparable mechanical elements—not shown in FIG. 2B—in such a manner that they contact the packaging sleeve 10 and pre-fold in the region of its bottom surface 8 or its gable surface 9. The fifth folding tools 27 can comprise a counterholder whose shape approximately corresponds to the cross-sectional area of the packaging sleeve 10. This enables the counterholder to be inserted into the packaging sleeve 10 before or during the pivoting movement of the other four folding tools 27 and to serve there as a stop for the other four folding tools 27. In contrast to the other four folding tools 27 the counterholder does not need to be pivotably mounted. Accordingly, it does not need to be controlled via the carriages 26, the control carriages 30 and the coupling rods 32 but can be firmly connected to the frame 24 and thus follow the vertical movement of the folding device 23.

FIG. 3 comprises a schematic view of the process steps during the pre-folding of packaging sleeves 10. For illustration the operating mode of an apparatus 14 according to the invention is conceptually divided into eight positions I-VIII in FIG. 3 which are each shown individually. For reasons of simplification many details of the apparatus 14 are omitted in FIG. 3. The regions of the apparatus 14 already described in connection with FIG. 2A or FIG. 2B are also provided with corresponding reference numbers in FIG. 3. Shown in particular are the upper control rail 22′ and the lower control rail 22″. The folding devices 23 are guided along the two control rails 22; this is accomplished by means of the rollers 28′, 28″.

In position I both control rails 22 are so far away from the conveyor belt 20 that the folding devices 23 and in particular the folding tools 27 fastened thereon have no contact with the packaging sleeves 10 which are located in the cells 21 of the conveyor belt 20. In the position shown in position I the control rails 22 have a large thickness D so that the movable carriages 26 are pressed in the direction of the folding tools 27. This has the result that the folding tools 27 are opened.

In position II the position of the lower folding device 23″ is unchanged. The upper folding device 23′ on the other hand has moved in the direction of the packaging sleeve 10 to be folded as a result of change in position of the upper control rail 22′. This has the result that the folding tools 27 of the upper folding device 23′ are located in the vicinity of the upper region of the packaging sleeve 10, i.e. in the region of the gable surfaces 9. In this position the folding process can be carried out. Since the thickness D of the upper control rail 22′ in position II however is unchanged, the position of the movable carriage 26 has not changed compared to position I so that the folding tools 27 of the upper folding device 23′ are in the open position as before.

Between position II and position III the lower folding device 23″ is displaced in the direction of the packaging sleeve 10 to be folded as a result of a change in position of the lower control rail 22″. In position III accordingly both the upper folding device 23′ and the lower folding device 23″ are located in a position in which the folding process can be carried out. However, the thickness D of the lower control rail 22″ is unchanged in position III so that the position of the movable carriage 26 of the lower folding device 23″ has not changed compared with position I and position II. The folding tools 27 of the lower folding device 23″ in position III are therefore as before in the open position so that no folding process is carried out. The thickness D of the upper control rail 22′ has however decreased significantly from position II to position III so that the movable carriage 26 of the upper folding device 23′ is pressed by the springs 29 in the direction of the upper control rail 22′. As a result of a mechanical connection between the movable carriage 26 and the folding tools 27, the described movement of the carriage 26 results in an actuation of the folding tools 27 of the upper folding device 23′. Due to the actuation of the folding tools 27 of the upper folding device 23′ the packaging sleeve 10 is firstly precisely aligned and then pre-folded in the region of the gable surfaces 9. The alignment of the packaging sleeve 10 is in particular possible since the folding tools 27 of the lower folding device 23″ in position III are not yet actuated so that the packaging sleeve 10 can still be displaced relative to the lower folding device 23″.

Between position III and position IV the thickness D of the lower control rail 22″ also decreases so that the folding tools 27 of the lower folding device 23″ are also actuated as a result of a displacement of the movable carriage 26. In position IV therefore both the folding tools 27 of the upper folding device 23′ and also the folding tools 27 of the lower folding device 23″ are active and in contact with the packaging sleeve 10.

Between position IV and position V the thickness D of the lower control rail 22″ increases again with the result that the movable carriage 26 is again pressed in the direction of the packaging sleeve 10. This has the result that the folding tools 27 of the lower folding device 23″ open again and release the packaging sleeve 10. The pre-folding of the bottom surfaces 8 of the packaging sleeve 10 is now completed. The folding tools 27 of the upper folding device 23′ in position V on the other hand are active as before. The position of the components in positions III and V is identical.

Between position V and position VI the position of the lower control rail 22″ changes again with the result that the lower folding device 23″ is again moved away from the packaging sleeve 10. The position of the upper folding device 23′ in position VI on the other hand is unchanged compared to position V. In the upper control rail 22′ not the position but the thickness D of the upper control rail 22′ varies between positions VI and VII. As a result of an increase in the thickness D of the upper control rail 22′ the movable carriage 26 of the upper folding device 23′ is again pressed in the direction of the packaging sleeve 10 with the result that the folding tools 27 of the upper folding device 23′ open again. Now the pre-folding of the gable surfaces 9 of the packaging sleeve 10 is completed. The position of the lower components in positions VI and II is identical; the position of the upper components on the other hand only again reaches the position from position II in position VII.

In position VIII the position of the lower folding device 23″ is unchanged compared with position VI and position VII. On the other hand, as a change in position of the upper control rail 22′ between position VII and position VIII, the upper folding device 23′ has been displaced in the direction of the upper control rail 22′. In position VIII accordingly both control rails 22 are so far away from the conveyor belt 20 that the folding devices 23 and in particular the folding tools 27 fastened thereon have no contact with the packaging sleeves 10 which are located in the cells 21 of the conveyor belt 20. A comparison between positions I and VIII shows outwardly folded triangular surfaces 13 as a result of the pre-folding. The rectangular surfaces 12 are on the other hand inwardly folded as a result of the pre-folding; however this cannot be identified in the view selected in FIG. 3.

FIG. 4A shows the folding tools 27 of an apparatus 14 according to the invention in the open position in a side view. In the apparatus 14 shown in FIG. 4A and in this respect preferred, there are five folding tools 27: the first folding tool 27 comprises a centrally arranged counterholder 27A which is introduced into the interior of the packaging sleeve 10 and whose shape approximately corresponds to the cross-sectional area of the packaging sleeve 10. In addition, there are provided two oppositely arranged surface folders 27B which are pivotably mounted. The surface folders 27B serve to fold the rectangular surfaces 12 of the packaging sleeve 10 inwards. Finally there are provided two oppositely arranged ear folders 27C which are also pivotably mounted. The rear one of the two ear folders 27C in FIG. 4A is concealed. The ear folders 27C serve to support one of the triangular surfaces 13 against the pressure of the surface folders 27B from below in order to form the ears 13′ of the packaging sleeve 10. For this purpose the ear folders 27C have a triangular region. The movements of the folding elements 27A, 27B and 27C are shown schematically by arrows.

FIG. 4B shows the folding tools 27 of an apparatus 14 according to the invention in the closed position in a side view. Compared to the open position from FIG. 4A, the two ear folders 27C have been pivoted outwards, i.e. away from the packaging sleeve 10 so that the triangular region of the ear folders 27C can serve as a support for folding the ears 13. The two surface folders 27B on the other hand have been pivoted inwards, i.e. towards the packaging sleeve 10 where the rectangular surfaces 12 of the packaging sleeve 10 also bend inwards. The position of the counterholder 27A is unchanged. In the position shown in FIG. 4B the two surface folders 27B press the gable surfaces 9 of the packaging sleeve 10 downwards, where (outside the packaging sleeve 10) the ear folders 27B and (inside the packaging sleeve 10) the counterholder 27A serve as a support.

FIG. 4C shows the folding tools 27 in the position from FIG. 4A in cross-section. The regions of the apparatus 14 already described in connection with FIG. 4A are provided with corresponding reference numbers in FIG. 4C. The tapered shape of the counterholder 27A can be seen particularly clearly, which counterholder firstly serves to provide two flat contact surfaces for the surface folders 27B and secondly enables the two rectangular surfaces 12 of the packaging sleeve 10 to be compressed as tightly as possible. In contrast to FIG. 4A, the rear ear folder 27C is shown in FIG. 4C.

FIG. 4D shows the folding tools 27 in the position from FIG. 4B in cross-section. The regions of the apparatus 14 already described in connection with FIG. 4B are provided with corresponding reference numbers in FIG. 4D. The course of the wall of the packaging sleeve 10 can be seen particularly clearly (shown in bold). The wall of the packaging sleeve 10 is compressed between the two surface folders 27B and (outside the packaging sleeve 10) the ear folders 27C as well as (inside the packaging sleeve 10) the counterholder 27A and thereby pre-folded. In contrast to FIG. 4B, the rear ear folder 27C is shown in FIG. 4D.

FIG. 5A shows the folding tools 27 of an apparatus 14 according to the invention in the open position in cross-section along the line VA-VA from FIG. 4A. The regions of the apparatus 14 already described in connection with FIG. 4A to FIG. 4D are provided with corresponding reference numbers in FIG. 5A. The counterholder 27A can be configured to be slightly wider in the transverse direction of the packaging sleeve 10, i.e. parallel to the front surface 5 and the rear surface 6, than the width of the front surface 5 and the rear surface 6. This has the effect that the triangular surfaces 13 of the packaging sleeve 10 are gently pressed outwards during insertion of the counterholders 27A and already abut against the ear folders 27C before the actual pre-folding.

Figure SB shows the folding tools 27 of an apparatus 14 according to the invention in the closed position in cross-section along the line VB-VB from FIG. 4B. The regions of the apparatus 14 already described in connection with FIG. 4A to FIG. 4D are provided with corresponding reference numbers in FIG. 5B. The outwardly projecting ears 13′ of the packaging sleeve 10 can be identified particularly clearly. The ears 13′ are formed whereby the two surface folders 27B (not shown in FIG. 5B) press the wall of the packaging sleeve 10 particularly in the region of the triangular surfaces 13 onto the two ear folders 27C.

The shape of the gable surfaces 9 of the packaging sleeve 10 achieved in FIG. 4B, FIG. 4D and FIG. 5B cannot be completely retained since the counterholder 27A must again be withdrawn upwards from the packaging sleeve 10 and thereby hits against the rectangular surfaces 12. In addition, a sufficiently large opening must be provided for the subsequent filling of the packaging sleeve 10. As a result of the withdrawal of the counterholder 27A and as a result of the elasticity of the material of the packaging sleeve 10, the gable surfaces 9 of the packaging sleeve 10 again move backwards a little way so that after completion of the pre-folding the packaging sleeve 10 approximately adopts the shape described previously in connection with FIG. 1D. FIG. 6 shows a system 33 known from the prior art for filling packages with foodstuffs (EP 0 112 605 A2). The individual stations of the system 33 are only shown schematically in FIG. 6 since FIG. 6 is merely intended to illustrate a possible area of application of an apparatus 14 according to the invention for the pre-folding of packaging sleeves 10. The packaging sleeves 10 (not shown in FIG. 6) are unfolded by a station 34 and transferred to the cells 21 of the conveyor belt 20. The system 33 comprises a first rotary machine 35 in which the gable surfaces 9 of the packaging sleeves 10 are pre-folded. The packaging sleeves 10 then pass through a station 36 in which the bottom surfaces 8 of the packaging sleeves 10 are pre-folded. The stations 35 and 36 can be replaced by an apparatus according to the invention. After the pre-folding the bottom surfaces 8 of the packaging sleeves 10 are folded together in a station 37 and sealed. The conveyor belt 20 is then guided around a second rotary machine 38 in which the packaging sleeves 10 closed on the underside are filled with foodstuffs. In a further station 39 the gable surfaces 9 of the packaging sleeves 10 are folded together and sealed. Finally in a further station 40 the packaging sleeves 10 now filled and closed are removed from the cells 21 of the conveyor belt 20 and again discharged from the system 33.

### LIST OF REFERENCE NUMBERS

1: Blank
2: Fold line
3, 4: Side surface
5: Front surface
6: Rear surface
7: Sealing surface
8: Bottom surface
9: Gable surface
10: Packaging sleeve
11: Longitudinal seam
12: Rectangular surface
13: Triangular surface
13′: Ears
14: Apparatus
15: Rotary frame
15′, 15″: Supporting element
16: Fixed frame
17: Bearing
18: Base
19: Axis of rotation
20: Conveyor belt
21: Cell
22, 22′, 22″: Control rail
23, 23′, 23″: Folding device
24: Frame
25: Rod
26: Carriage
27: Folding tool
27A: Counterholder
27B: Surface folder
27C: Ear folder
28, 28′, 28″: Roller
29: Spring
30: Control carriage
31: Guide rail
32: Coupling rod
33: System
34: Station for unfolding
35: Station for pre-folding gable surfaces
36: Station for pre-folding bottom surfaces
37: Station for folding and sealing bottom surfaces
38: Station for filling
39: Station for folding and sealing gable surfaces
40: Station for discharging
D: Thickness (of control rail 22)

1.-25. (canceled)

26. An apparatus for the pre-folding of packaging sleeves comprising:
at least one folding device with folding tools for pre-folding the bottom surfaces of a packaging sleeve and
at least one folding device with folding tools for pre-folding the gable surfaces of a packaging sleeve,
wherein
all the folding devices are mounted movably in the vertical and in the horizontal direction.

27. The apparatus according to claim 26, further comprising a rotary frame which is mounted rotatably about an axis of rotation running centrally through the device.

28. The apparatus according to claim 27, wherein the rotary frame comprises vertically running rods on which the folding devices are mounted movably.

29. The apparatus according to claim 27, further comprising a stationary fixed frame which is disposed inside the rotary frame.

30. The apparatus according to claim 29, further comprising a lower control rail which is fastened to the fixed frame and along which the at least one folding device for pre-folding the bottom surfaces of the packaging sleeves is movably guided.

31. The apparatus according to claim 30, further comprising an upper control rail which is fastened to the fixed frame and along which the at least one folding device for pre-folding the gable surfaces of the packaging sleeves is movably guided.

32. The apparatus according to claim 31, wherein the lower control rail and/or the upper control rail have a thickness which varies along their length.

33. The apparatus according to claim 26, wherein the folding devices comprise a rigid frame and a carriage which is mounted movably relative to the frame.

34. The apparatus according to claim 33, wherein the movable carriage is connected mechanically to the folding tools.

35. The apparatus according to claim 33, wherein the movable carriage is connected mechanically to a control carriage by at least one guide rail.

36. The apparatus according to claim 35, wherein the control carriage is connected mechanically to the folding tools by at least one coupling rod.

37. The apparatus according to claim 33, wherein the folding devices have at least one spring which is clamped between the frame and the movable carriage.

38. The apparatus according to claim 26, wherein the apparatus comprises at least six folding devices for pre-folding the bottom surfaces of the packaging sleeves and at least six folding devices for pre-folding the gable surfaces of the packaging sleeves.

39. The apparatus according to claim 26, wherein each folding device comprises a plurality of movably mounted folding tools.

40. The apparatus according to claim 26, further comprising means for positive connection to a conveyor belt with cells fastened thereon.

41. A method for pre-folding packaging sleeves comprising the following steps:
a) aligning a packaging sleeve,
b) pre-folding the gable surfaces of the packaging sleeve and
c) pre-folding the bottom surfaces of the packaging sleeve,
wherein steps b) and c) overlap in time,
wherein
the packaging sleeve is moved in the horizontal direction in steps b) and c).

42. The method according to claim 41, wherein the packaging sleeve is moved at constant speed.

43. The method according to claim 41, wherein the packaging sleeve is moved along a circular path.

44. The method according to claim 41, wherein the packaging sleeve is moved by a conveyor belt with holders or cells fastened thereon.

45. The method according to claim 41, wherein
in steps b) and c) a counterholder is inserted into the packaging sleeve.

46. The method according to claim 41, wherein
in steps b) and c) two oppositely arranged surface folders are pivoted in the direction of the packaging sleeve.

47. The method according to claim 41, wherein
in steps b) and c) two oppositely arranged ear folders are pivoted away from the packaging sleeve.

48. The method according to claim 41, wherein
step b) begins earlier than step c).

49. The method according to claim 41, wherein
step c) ends earlier than step b).

50. The method according to claim 41, wherein
step b) and step c) run completely synchronously.
